(19) United States
(12) Patent Application Publication
(10) Pub. No.: US 2026/0220395 A1
(43) Pub. Date: Jul. 30, 2026

(54) REVIEW SUPPORT DEVICE, REVIEW SUPPORT METHOD, AND RECORDING MEDIUM

(71) Applicant: NEC Corporation, Tokyo (JP)

(72) Inventors: Misato YAMADA, Tokyo (JP); Tokiyoshi KUROGI, Tokyo (JP)

(73) Assignee: NEC Corporation, Tokyo (JP)

(21) Appl. No.: 19/457,358

(22) Filed: Jan. 23, 2026

(30) Foreign Application Priority Data
Jan. 30, 2025 (JP) 2025-013944

(51) Int. Cl. G06F 40/42; G06F 16/3329; G06F 16/353

(52) U.S. Cl. CPC G06F 40/42; G06F 16/3329; G06F 16/353

(57) ABSTRACT

In the review support device, the target data acquisition unit acquires target data for review. The non-public information acquisition unit acquires non-public information regarding the target data. The material type detection unit detects a material type of the target data. The information conversion unit converts the target data into information readable by a large language model, based on the material type and the non-public information. This device further enhances decision making by an artificial intelligence (AI) model to efficiently determine compliance of target data.

### INCORPORATION BY REFERENCE

This application is based upon and claims the benefit of priority from Japanese Patent Application 2025-013944, filed on January 30, 2025, the disclosure of which is incorporated herein in its entirety by reference.

### TECHNICAL FIELD

The present disclosure relates to a technique for supporting review by using generative AI.

### BACKGROUND ART

The utilization of a system that generates, by using generative artificial intelligence (AI), an answer based on a directive input by a user is progressing. JP2024-129086A describes a method for generating instruction data for a large model that is a type of generative AI, in which a reference instruction based on a natural language is structurally disassembled, thereby enhancing flexibility of instruction training data generation process and enhancing an instruction compliance capability of the large model.

### SUMMARY

Conventionally, in a case of reviewing whether advertisements and the like displayed on various media conform to legal regulations or voluntary regulations of industry groups, since a person in charge of review who has knowledge performs visual confirmation, there has been a problem that man-hours become enormous and a lead time becomes long.

An object of the present disclosure is to provide, in review of target data, support for reducing a burden on the person in charge of the review and improving the accuracy of the review.

According to an example aspect of the present invention, there is provided a review support device including:

a target data acquisition means for acquiring target data for review;

a non-public information acquisition means for acquiring non-public information regarding the target data;

a material type detection means for detecting a material type of the target data;

information conversion means for converting the target data into information readable by a large language model, based on the material type and the non-public information; and

a prompt generation means for generating a plurality of prompts to be input to the large language model, based on the converted target data.

According to another example aspect of the present invention, there is provided a review support method executed by a review support device, the method including:

acquiring target data for review;

acquiring non-public information regarding the target data;

detecting a material type of the target data;

converting the target data into information readable by a large language model, based on the material type and the non-public information; and

generating a plurality of prompts to be input to the large language model, based on the converted target data.

According to still another example aspect of the present invention, there is provided a program executed by a review support device including a computer, the program causing the computer to execute processing including:

acquiring target data for review;

acquiring non-public information regarding the target data;

detecting a material type of the target data;

converting the target data into information readable by a large language model, based on the material type and the non-public information; and

generating a plurality of prompts to be input to the large language model, based on the converted target data.

According to the present disclosure, it is possible to provide, in review of target data, support for reducing a burden on a person in charge of the review and improving the accuracy of the review.

### BRIEF DESCRIPTION OF THE DRAWINGS

FIG. 1 illustrates an example of a schematic configuration of a review support system according to the present disclosure;

FIGS. 2A and 2B are block diagrams illustrating examples of hardware configurations of a server and a user terminal;

FIG. 3 is a diagram schematically illustrating processing in the review support system;

FIG. 4 is an example of information that can be acquired by uploading a material;

FIG. 5 is an example of material information;

FIG. 6 is an example of non-public information;

FIG. 7 is an example of an output format;

FIG. 8 is a block diagram illustrating an example of a functional configuration of the server;

FIG. 9 is an example of format conversion of a material type;

FIG. 10 is an example in which summarization is executed a plurality of times at a prompt;

FIGS. 11A and 11B are examples of an input pattern and an output pattern;

FIG. 12 is an example of a data structure of a prompt DB;

FIG. 13 is an example of a data structure of a management DB;

FIG. 14 is a flowchart of review support processing;

FIG. 15 is a flowchart of a summarization process;

FIG. 16 is a block diagram illustrating a functional configuration of a review support device; and

FIG. 17 is a flowchart by the review support device.

### EXAMPLE EMBODIMENTS

Preferred example embodiments of the present disclosure will be described with reference to the accompanying drawings.

### First Example Embodiment

### Overall Configuration

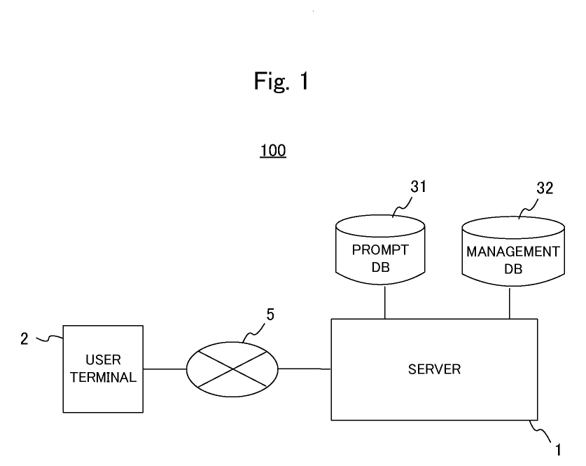

FIG. 1 is an example of a schematic configuration of a review support system 100 to which a review support device of the present disclosure is applied. The review support system 100 is a system that can acquire a result of reviewing target data without requiring a user to input a directive text. Here, the user is, for example, a person in charge of review who reviews the target data. The target data is data such as advertisements and broadcast shows displayed on various media, and is also referred to as a "material" in the present disclosure. The review is to check whether the advertisements and the broadcast shows comply with legal regulations, voluntary regulations of industry groups, and examination standards of media. In this manner, by reviewing the target data, it is possible to ensure soundness of the advertisements and the broadcast shows displayed on the various media.

Advertisements using the Internet as a medium are expected to grow in the future, and a market size is also expanding. However, with an increase in advertisements using the Internet as the medium including social networking services (SNSs), there have been many social problems due to haphazard review. In response to this situation, the government is also promoting a policy to reinforce regulations on advertisement content as needed. Therefore, there is an increasing demand for easily and appropriately reviewing advertisements and shows displayed not only on the Internet but also on various media such as televisions and magazines.

According to the review support system 100, the user does not need to input a directive text that is difficult for a person with little knowledge of the generative AI, and can easily review the target data by using the generative AI. In addition, according to the review support system 100, by using the generative AI for the review of the target data, it is possible to provide support for reducing a burden on the person in charge of the review and improving the accuracy of the review.

In the review support system 100 of FIG. 1, a server 1 and a user terminal 2 are communicably connected via a network 5 such as the Internet. In addition, the server 1 is connected to a prompt database (Hereinafter, a "database" is referred to as a "DB") 31 and a management DB 32.

In the review support system 100 of FIG. 1, the server 1 and the user terminal 2 are communicably connected via the network 5 such as the Internet. The user terminal 2 is a tablet, a PC, or the like used by a user who reviews target data. The user terminal 2 transmits, to the server 1, materials that are registered by the user via an input screen and are to be reviewed and information regarding output formats and the like of the materials and results, receives a result of reviewing the materials from the server 1, and displays the result.

The server 1 is an information processing device that processes, stores, and transmits/receives various kinds of data, and receives, from the user terminal 2, the materials to be reviewed and the information regarding the output formats and the like of the materials and the results. Also, the server 1 transmits, to the user terminal 2, a review result acquired by inputting a prompt generated based on the received information to the generative AI. As an example, the generative AI is a language model such as a natural language model or a large language model (LLM) capable of understanding multimodal information. Furthermore, the server 1 may be a virtual server in a cloud environment. The server 1 is an example of the review support device of the present disclosure.

### Hardware Configuration

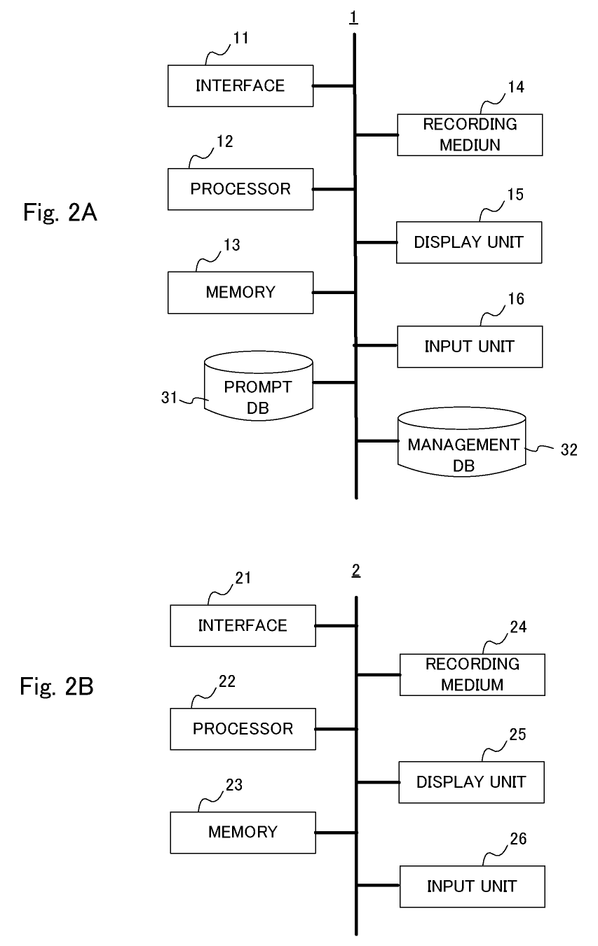

FIG. 2A is a block diagram illustrating an example of a hardware configuration of the server 1. As illustrated in FIG. 2A, the server 1 includes an interface 11, a processor 12, a memory 13, a recording medium 14, a display unit 15, and an input unit 16. These constituent elements, the prompt DB 31, and the management DB 32 are connected to each other via a bus.

The interface 11 exchanges data with the user terminal 2. The interface 11 receives, from the user terminal 2, a material to be reviewed, and information regarding an output format and the like of the material and a result, and transmits a result of the review.

The processor 12 is a computer such as a Central Processing Unit (CPU), and controls the entire server 1 by executing a program prepared in advance. As the processor 12, a CPU, a graphics processing unit (GPU), a digital signal processor (DSP), a micro processing unit (MPU), a floating point number processing unit (FPU), a physics processing unit (PPU), a tensor processing unit (TPU), a quantum processor, a microcontroller, a combination of these, or the like can be used.

The memory 13 includes a read only memory (ROM), a random access memory (RAM), and the like. The memory 13 stores a program executed by the processor 12. The memory 13 is also used as a work memory during execution of various types of processing by the processor 12.

The recording medium 14 is a non-volatile non-transitory recording medium such as a disk-shaped recording medium or a semiconductor memory, and is attachable to and detachable from the server 1. The recording medium 14 records various programs to be executed by the processor 12. When the server 1 executes review support processing, the program recorded in the recording medium 14 is loaded into the memory 13 and executed by the processor 12.

The display unit 15 displays a predetermined image by, for example, a liquid crystal display (LCD). The input unit 16 is a keyboard, a mouse, a touch panel, or the like, and is used by an operator who manages the server 1.

The prompt DB 31 stores an input pattern and an output pattern each of which is a form of a directive text requesting review of a material. Although details will be described later, the input pattern is the form of the directive text associated with the material itself and information regarding the material. On the other hand, the output pattern is the form of the directive text associated with the output format of the result output by the LLM. The server 1 generates the directive text by combining the input pattern and the output pattern, based on the material, a material type, the material information, and the output format registered by the user.

The management DB 32 stores and manages the directive text input to the LLM and the result and accuracy output by the LLM in response to the input of the prompt including the directive text in association with each other. The “directive text” is a sentence indicating processing to be executed by the LLM. In addition, the “prompt” includes the directive text and the material, and is data input to the LLM. Although details will be described later, the management DB 32 may manage, for example, the material, the material type, the material information, the output format, the number of times of re-execution of processing, and the like in association with each other. In this manner, the server 1 generates a prompt with reference to the management DB 32 that manages the directive text, a result thereof, and accuracy of the result, making it possible to improve the accuracy of the result. In other words, the data stored in the management DB 32 can be used by the server 1 to acquire a more accurate result in the future.

FIG. 2B is a block diagram illustrating an example of a hardware configuration of the user terminal 2. As illustrated in FIG. 2B, the user terminal 2 includes an interface 21, a processor 22, a memory 23, a recording medium 24, a display unit 25, and an input unit 26.

The interface 21 exchanges data with the server 1 via the network 5. The interface 21 transmits, to the server 1, a material to be reviewed, and information regarding an output format and the like of the material and a result, and receives a result of reviewing the material from the server 1.

The processor 22 is a computer such as a CPU, and controls the entire user terminal 2 by executing a program prepared in advance. As the processor 22, it is possible to use a CPU, a GPU, a DSP, an MPU, an FPU, a PPU, a TPU, a quantum processor, a microcontroller, a combination of these, or the like.

The memory 23 includes a ROM and a RAM. The memory 23 stores a program executed by the processor 22. The memory 23 is also used as a work memory during execution of various types of processing by the processor 22.

The recording medium 24 is a non-volatile non-transitory recording medium such as a disk-shaped recording medium or a semiconductor memory, and is attachable to and detachable from the user terminal 2. The recording medium 24 records various programs to be executed by the processor 22. The display unit 25 displays a predetermined image by, for example, an LCD. The input unit 26 is a touch panel or the like, and is used when the user performs a predetermined operation.

### Processing in Review Support System

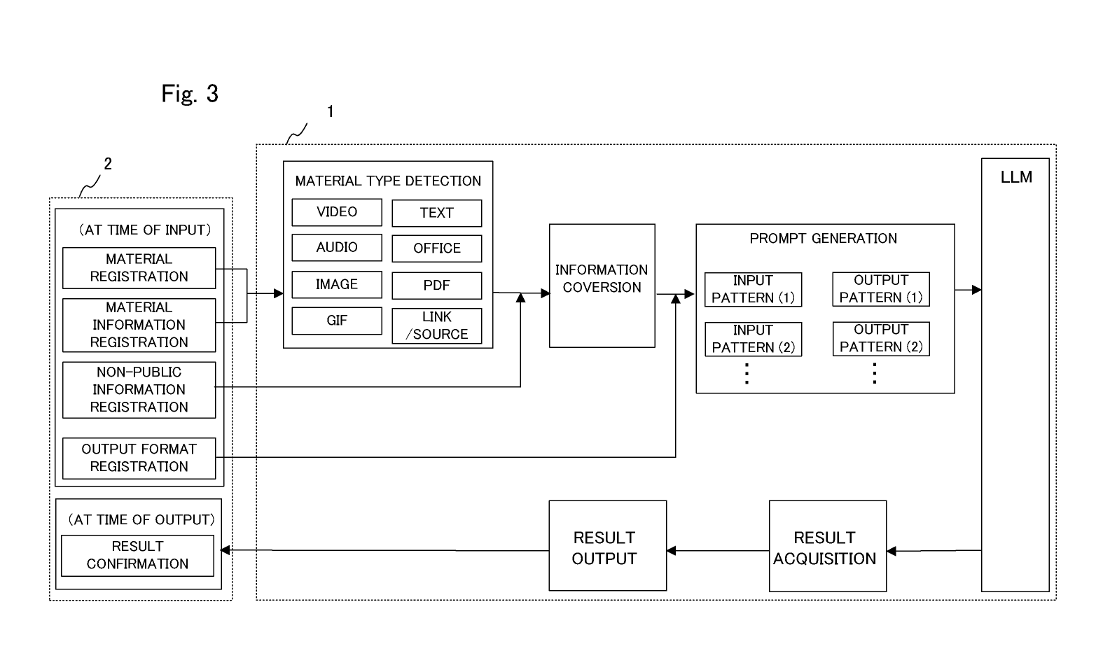

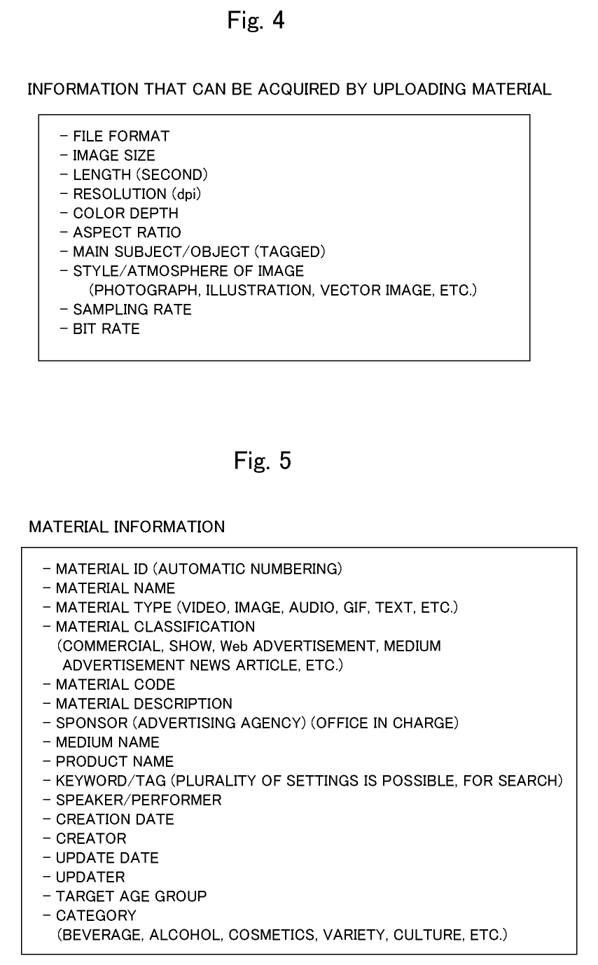

FIG. 3 is a diagram schematically illustrating processing in the review support system 100. As illustrated in FIG. 3, the user terminal 2 performs material registration, material information registration, non-public information registration, and output format registration at a time of inputting target data, and confirms a result at a time of outputting the result. The material registration is registration of a material to be the target data, and the user uploads the material to be reviewed on the input screen. FIG. 4 is an example of information that can be acquired by uploading the material. As illustrated in FIG. 4, for example, the user terminal 2 can acquire a file format, an image size, a length (second), a resolution (dpi), a color depth, an aspect ratio, a tagged main subject or object, a style or atmosphere of an image such as a photograph or an illustration, a sampling rate, a bit rate, and the like according to the uploaded material.

The material information registration is registration of the information regarding the material, and the user optionally registers various kinds of information regarding the material on the input screen. FIG. 5 is an example of the material information. As illustrated in FIG. 5, the user registers the material information by selecting or inputting a material name, a material type, a material classification, a material code, a material description, a sponsor and an advertising agency, a medium name, a product name, a keyword or a tag, a speaker or a performer, a creation date, a creator, an update date, an updater, a target age group, and a category, according to the material on the input screen. The material information is not limited to the example illustrated in FIG. 5, and can be optionally set to a campaign industry type, a campaign content, a campaign period, an appealing merchandise, and the like. In addition, the material information may be designed to be registerable by the user selecting information automatically detected at a stage where the material is uploaded or performing an optional input on the input screen.

A material ID for identifying the material is assigned by automatic numbering, and is registered as part of the material information. The material type is a type of material, and examples thereof include a video, an image, audio, graphics interchange format (GIF), text, Word and Excel included in Microsoft Office, portable document format (PDF), and a predetermined link and source. The material classification is a classification of the material, and examples thereof include a commercial, a show, a Web advertisement, a medium advertisement, a news article, a radio sound source, a script, a storyboard, and the like. The category is a category included in the material, and includes a category to which an advertisement such as a beverage, alcohol, or cosmetics belongs, a category to which a show such as variety or culture belongs, and the like.

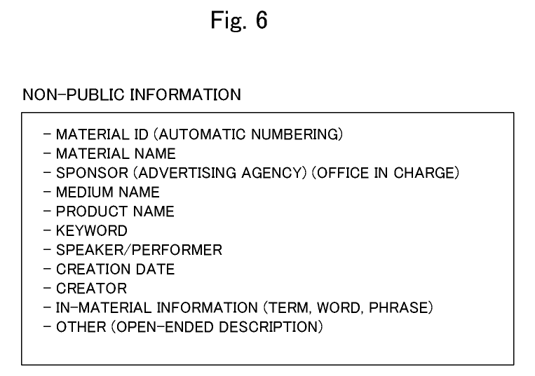

The non-public information registration is registration of the non-public information, and the user optionally registers various kinds of information to be non- public on the input screen. The non-public information refers to information that is not desired to be learned by the LLM used for the review, in other words, information that is not desired to be input to the LLM. FIG. 6 is an example of the non-public information. As illustrated in FIG. 6, the user registers the non-public information by inputting, on the input screen, a material name, a sponsor and an advertising agency, a medium name, a product name, a keyword, a speaker or a performer, a creation date, a creator, a word or a phrase included in the material, and the like that are desired to be non-public according to the material. Specifically, for example, in a case where the material classification is a commercial and it is desired to prevent leakage of information on a performer before broadcasting of the commercial, the user registers the performer in the non-public information. The non-public information may be designed to be registerable by the user selecting, on the input screen, the information automatically detected at the stage where the material is uploaded or information reflected at the time of registering the material information.

The material ID for identifying the material is assigned by automatic numbering, and is registered as part of the non-public information.

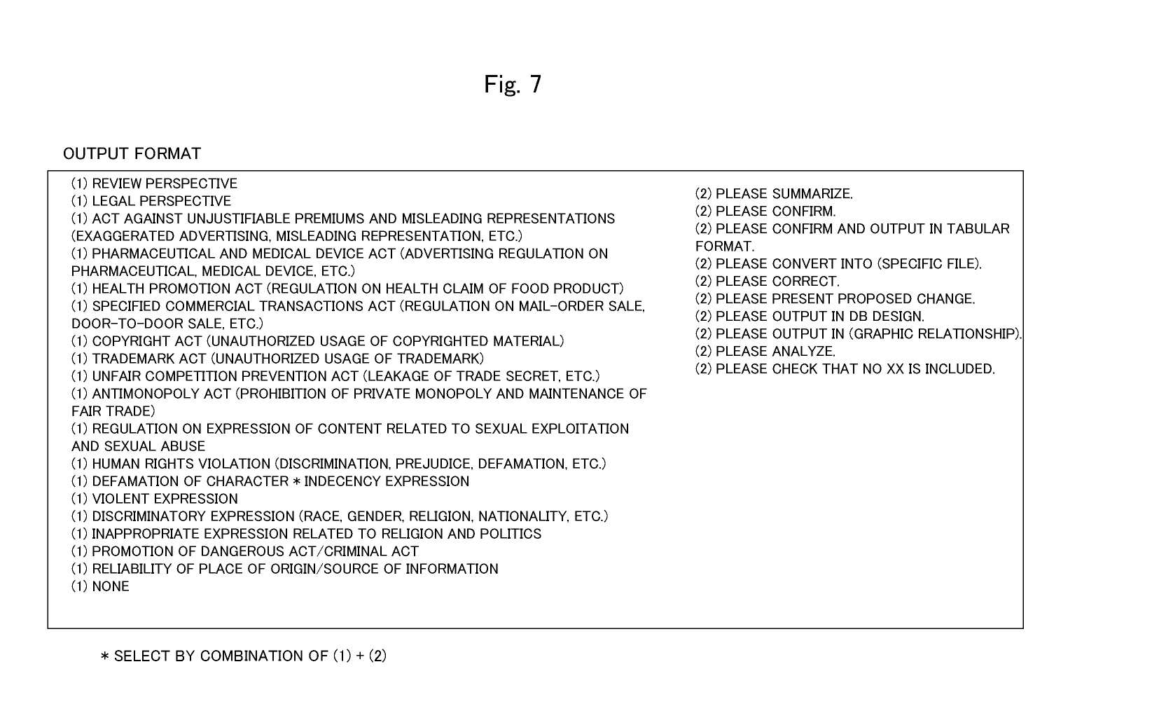

The output format registration is registration of an output format of a result by the LLM, and the user registers an output format indicating what type of result is desired to be output by selecting or inputting the output format on the input screen. FIG. 7 is an example of the output format. The output format is composed of two aspects that are from which perspective the material is reviewed and how the result of the review is output, and the user registers the output format by selecting and combining options displayed on the input screen.

As illustrated in FIG. 7, the options for from which perspective the material is reviewed include, for example, review perspective, legal perspective, Act against Unjustifiable Premiums and Misleading Representations, Pharmaceutical and Medical Device Act, Health Promotion Act, Specified Commercial Transactions Act, Copyright Act, Trademark Act, Unfair Competition Prevention Act, Antimonopoly Act, regulation on expression of content related to sexual exploitation and sexual abuse, human rights violation, defamation of character/indecency expression, violent expression, discriminatory expression, inappropriate expression related to religion and politics, promotion of dangerous act/criminal act, and reliability of place of origin and source of information. Here, the "review perspective" indicates that the material is reviewed comprehensively, and the "legal perspective" indicates that the material is reviewed whether it complies with legal regulations. The specific act name indicates that the material is reviewed whether it complies with the regulations of the act, and the others such as the "discriminatory expression" indicate that the material is reviewed whether there is a problem from the perspective of the discriminatory expression. Note that from which perspective the material is reviewed is not limited to one option, but may be selected from the plurality of options.

As illustrated in FIG. 7, the options for how the result of the review is output include, for example, please summarize, please confirm, please confirm and output in tabular format, please convert into specific file, please correct, please present proposed change, please output in DB design, please output in graphic relationship, please analyze, and please check that no xx is included. Note that how the result of the review is output is not limited to one option, but may be selected from the plurality of options.

For example, in a case where, on the input screen by using the user terminal 2, the user selects “Act against Unjustifiable Premiums and Misleading Representations” for from which perspective the material is reviewed and selects “please confirm and output in tabular format” for how the result of the review is output, the output format is “please confirm and output in tabular format from perspective of Act against Unjustifiable Premiums and Misleading Representations”. In this case, the user can acquire a result of confirming the material from the perspective of Act against Unjustifiable Premiums and Misleading Representations in the tabular format. In addition, for example, in a case where the user selects “none” for from which perspective the material is reviewed and “please summarize” for how the result of the review is output on the input screen, the output format is “please summarize”. In this case, the user can acquire a result of summarizing the material.

In addition, for example, in a case where the user selects "Pharmaceutical and Medical Device Act" and "Health Promotion Act" for from which perspective the material is reviewed and "please confirm" for how the result of the review is output on the input screen, the output format is "please confirm from the perspective of Pharmaceutical and Medical Device Act and Health Promotion Act". In this case, the user can acquire a result of confirming the material from the perspective of Pharmaceutical and Medical Device Act and Health Promotion Act. In addition, for example, in a case where the user selects "violent expression" for from which perspective the material is reviewed and "please check whether something is included" and "please present proposed change" for how the result of the review is output on the input screen, the output format is "please check that no violent expression is included and please present proposed change". In this case, the user can check that no violent expression is included, and if the violent expression is included, the user can acquire a result of presenting the proposed change of the violent expression. Note that the user may select the plurality of options for each of from which perspective the material is reviewed and how the result of the review is output.

As illustrated in FIG. 3, the server 1 performs material type detection, information conversion, and prompt generation, and inputs the generated prompt to the LLM. Next, the server 1 performs result acquisition and result output, acquires a result output by the LLM, and transmits the result as the result of reviewing the material to the user terminal 2. Details will be described in the following functional configuration.

### Functional Configuration

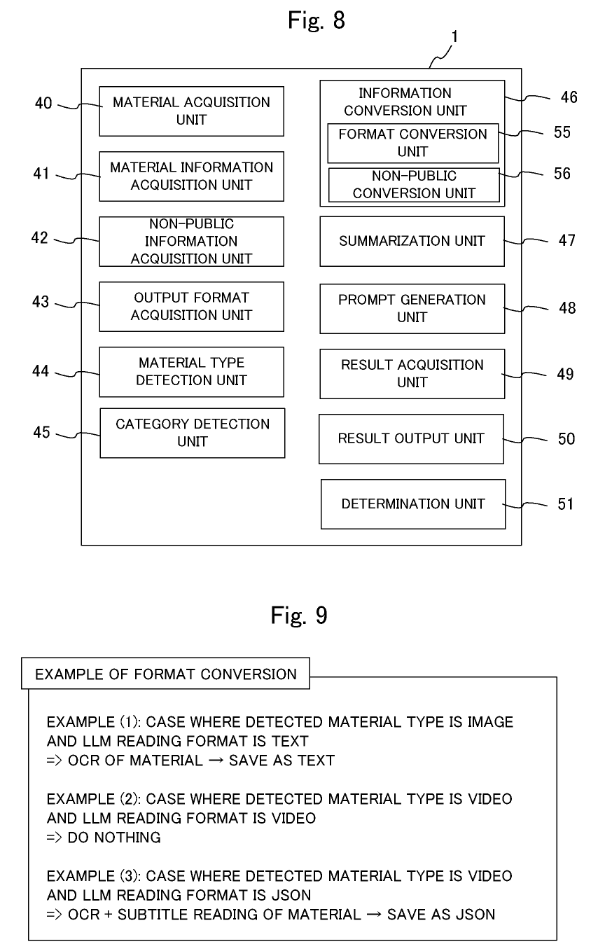

FIG. 8 is a block diagram illustrating an example of a functional configuration of the server 1. The server 1 functionally includes a material acquisition unit 40, a material information acquisition unit 41, a non-public information acquisition unit 42, an output format acquisition unit 43, a material type detection unit 44, a category detection unit 45, an information conversion unit 46, a summarization unit 47, a prompt generation unit 48, a result acquisition unit 49, a result output unit 50, and a determination unit 51.

The material acquisition unit 40, the material information acquisition unit 41, the non-public information acquisition unit 42, the output format acquisition unit 43, the material type detection unit 44, the category detection unit 45, the information conversion unit 46, the summarization unit 47, the prompt generation unit 48, the result acquisition unit 49, the result output unit 50, and the determination unit 51 are implemented by the processor 12 executing a program.

The material acquisition unit 40 acquires a material to be reviewed from the user terminal 2.

The material information acquisition unit 41 acquires material information regarding the material from the user terminal 2.

The non-public information acquisition unit 42 acquires, from the user terminal 2, non-public information that is not desired to be learned by the LLM used for the review.

The output format acquisition unit 43 acquires an output format of a result by the LLM from the user terminal 2.

The material type detection unit 44 detects a material type from information that can be acquired from an uploaded material and the material information. Specifically, the material type detection unit 44 detects the material type by reading an extension or the like of the material.

The category detection unit 45 detects a category and a material classification from the information that can be acquired from the uploaded material and the material information.

The information conversion unit 46 converts the material into information readable by the LLM, based on the material type and the non-public information. The information conversion unit 46 includes a format conversion unit 55 and a non-public conversion unit 56.

The format conversion unit 55 converts the material type of the material into a format readable by the LLM. FIG. 9 illustrates an example of format conversion. As in the example illustrated in FIG. 9, in a case where the detected material type is “image” and the LLM reading format is “text”, the format conversion unit 55 converts the image as the material into text by optical character recognition (OCR) and saves the text. As in another example illustrated in FIG. 9, in a case where the detected material type is “video” and the LLM reading format is “video”, the format conversion unit 55 does not execute the process of converting the material. As in still another example illustrated in FIG. 9, in a case where the detected material type is “video” and the LLM reading format is “Java Script Object Notation (JSON)”, the format conversion unit 55 converts the video as the material into JSON by character recognition and subtitle reading by OCR, and saves the JSON.

The non-public conversion unit 56 converts the information that is included in the material and is not desired to be learned by the LLM into other information, based on the non-public information. For example, in a case where a material has the material type of text and the material classification of a commercial script, and the non-public information is the performer “Taro Yamada”, the non-public conversion unit 56 determines whether a character string “Taro Yamada” is included in the text that is the material. If the character string “Taro Yamada” is not included in the text, the non-public conversion unit 56 does not execute the process of converting the material. On the other hand, if the character string “Taro Yamada” is included in the text, the non-public conversion unit 56 executes the process of converting “Taro Yamada” included in the material into censorship dots such as “XXXX” or another character string.

If the material has undergone the format conversion, the non-public conversion unit 56 executes the conversion process according to the non-public information based on the material after the format conversion.

In a case where the LLM has difficulty in reading due to a large data amount of the material, the summarization unit 47 acquires a summary of the material by executing summarization a plurality of times at a prompt. Specifically, the summarization unit 47 sets a threshold of the data amount readable by the LLM, and repeatedly summarizes the material until the data amount of the material becomes smaller than the threshold.

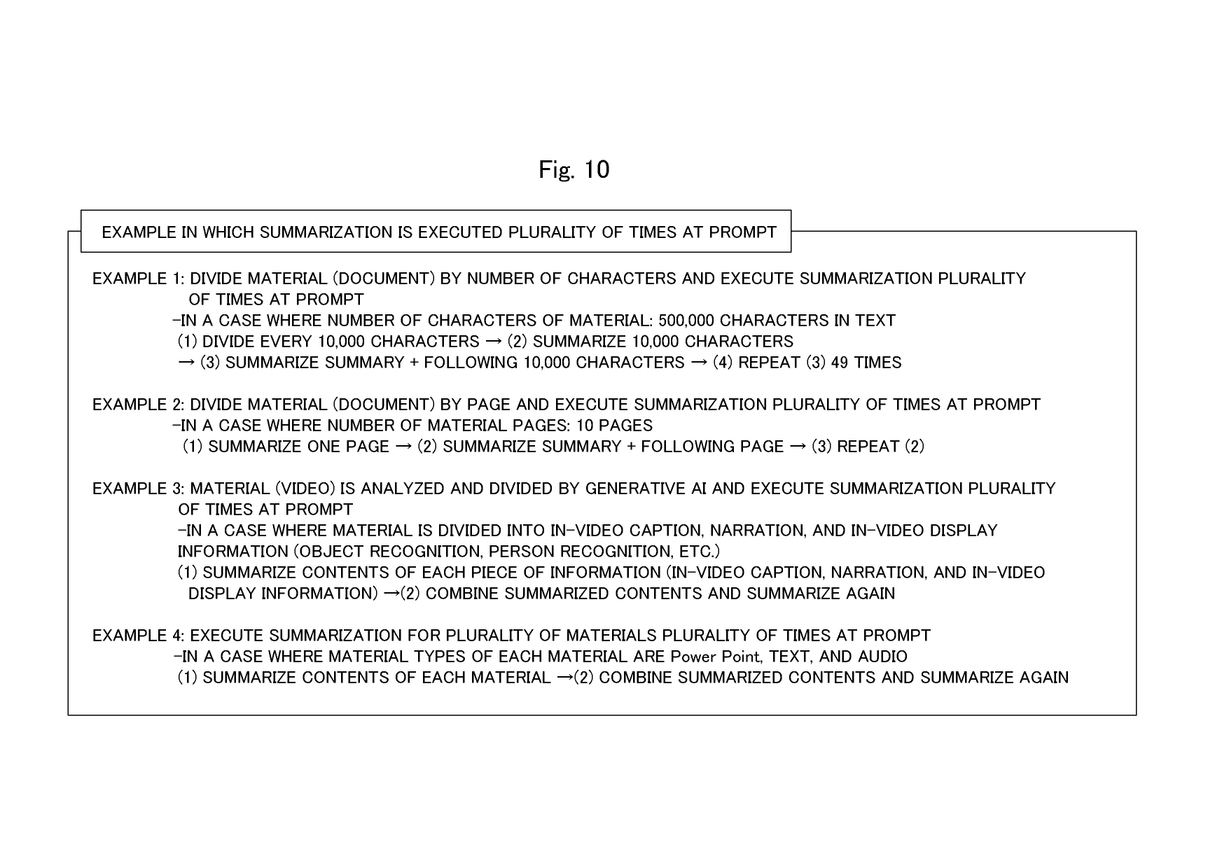

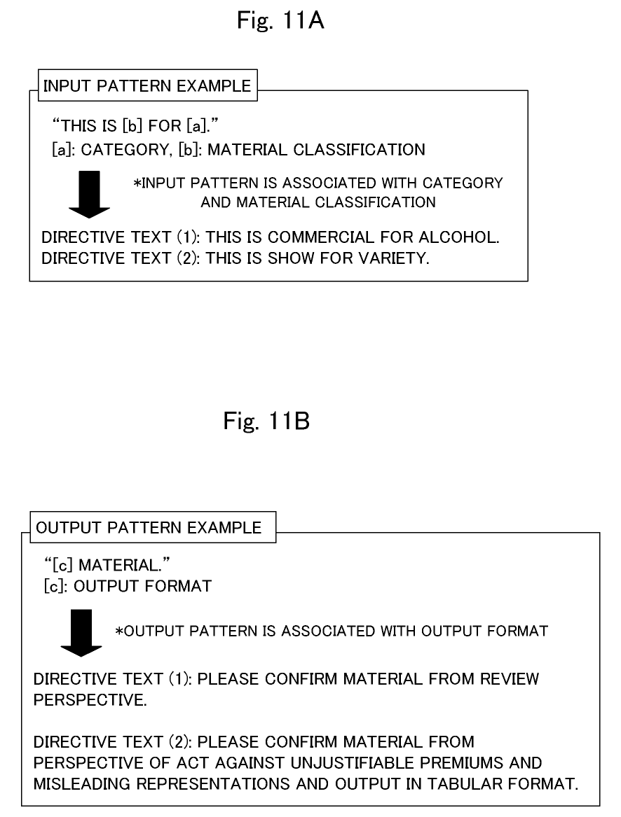

FIG. 10 illustrates an example in which summarization is executed a plurality of times at a prompt. In the example illustrated in FIG. 10, in a case where the number of characters of the material is 500,000 characters in text, the summarization unit 47 divides the material every 10,000 characters and summarizes contents of the first 10,000 characters. Specifically, the summarization unit 47 inputs a prompt including the first 10,000 characters and a directive text requesting a summary of the first 10,000 characters to the LLM, and acquires the summary output from the LLM. Next, the summarization unit 47 summarizes contents obtained by adding the following 10,000 characters to the acquired summary. Specifically, the summarization unit 47 inputs a prompt including the acquired summary and the following 10,000 characters and a directive text requesting a summary of the acquired summary and the following 10,000 characters to the LLM, and acquires the summary output from the LLM. In this manner, by repeating the process of summarizing the contents obtained by adding the following 10,000 characters to the summary, the summarization unit 47 can reduce the data amount of the material having the number of characters of 500,000 to less than the threshold.

In another example illustrated in FIG. 10, in a case where the material includes a plurality of pages, the summarization unit 47 summarizes contents of the first page. Specifically, the summarization unit 47 inputs a prompt including the first page and a directive text requesting a summary of the first page to the LLM, and acquires the summary output from the LLM. Next, the summarization unit 47 summarizes contents obtained by adding the following page to the acquired summary. Specifically, the summarization unit 47 inputs a prompt including the acquired summary and the following page and the directive text requesting a summary of the acquired summary and the following page to the LLM, and acquires the summary output from the LLM. In this manner, by repeating the process of summarizing the contents obtained by adding the following page to the summary, the summarization unit 47 can reduce the data amount of the material including the plurality of pages to less than the threshold.

In still another example illustrated in FIG. 10, in a case where the material is a video, the summarization unit 47 analyzes and divides the video by using predetermined generative AI, and summarizes contents of each piece of divided information. Specifically, the summarization unit 47 divides the video that is the material into an in-video caption, a narration, and in-video display information by using the predetermined generative AI. Then, the summarization unit 47 inputs a prompt including the in-video caption, the narration, and the in-video display information and a directive text requesting summaries of the each piece of information to the LLM, and acquires the summaries of the each piece of information output from the LLM. Next, the summarization unit 47 combines the summarized contents of the each piece of information and summarizes them again. Specifically, the summarization unit 47 inputs the acquired summaries of the each piece of information and a prompt requesting the summary of the contents that combines the summaries of the each piece of information to the LLM, and acquires the summary output from the LLM. In this manner, by dividing the material and summarizing again the contents that combines the summaries of the each piece of divided information, the summarization unit 47 can reduce the data amount of the material to less than the threshold.

In yet another example illustrated in FIG. 10, in a case where there are a plurality of materials, the summarization unit 47 summarizes each material. Specifically, in a case where material types of the plurality of materials are PowerPoint, text, and audio, the summarization unit 47 inputs a prompt including the materials of PowerPoint, the text, and the audio, and a directive text requesting the summary of each material to the LLM, and acquires the summary of each material output from the LLM. Next, the summarization unit 47 combines the summarized contents of each of the materials and summarizes them again. Specifically, the summarization unit 47 inputs the acquired summaries of each of the materials and a prompt requesting the summary of the contents that combines the summaries of each of the materials to the LLM, and acquires the summary output from the LLM. In this manner, in the case where there are the plurality of materials, by summarizing again the contents that combines the summaries of each of the materials, the summarization unit 47 can reduce the data amount of the plurality of materials to less than the threshold.

The prompt used by the summarization unit 47 may be generated by the following prompt generation unit 48 or may be held by the summarization unit 47 in advance.

The prompt generation unit 48 generates a prompt for the LLM based on the material after the information conversion by the information conversion unit 46 and/or the summary of the material acquired by the summarization unit 47. In a case where there is no information conversion or summary, the prompt generation unit 48 generates the prompt based on the material. Specifically, the prompt generation unit 48 generates a directive text by combining the input pattern that is the directive based on the material and the output pattern that is the directive based on the output format, based on the material, the material type, the output format, and the like. The directive text is divided into the input pattern and the output pattern, and these two patterns are combined to form one directive text.

FIGS. 11A and 11B are examples of the input pattern and the output pattern. As illustrated in FIG. 11A, by applying the category to [a] and the material classification to [b] of “This is [b] for [a].”, a directive text of the input pattern associated with the category and the material classification is obtained. Specifically, the input pattern with the category of “alcohol” and the material classification of “commercial” is “This is commercial for alcohol.”. In addition, the input pattern with the category of “variety” and the material classification of “show” is “This is show for variety.”.

As illustrated in FIG. 11B, by applying the output format to [c] of “[c] material.”, a directive text of the output pattern associated with the output format is obtained. Specifically, the output pattern with the output format of “please confirm from review perspective” is “Please confirm material from review perspective.”. In addition, the output pattern with the output format of “please confirm from perspective of Act against Unjustifiable Premiums and Misleading Representations and output in tabular format” is “Please confirm material from perspective of Act against Unjustifiable Premiums and Misleading Representations and output in tabular format.”.

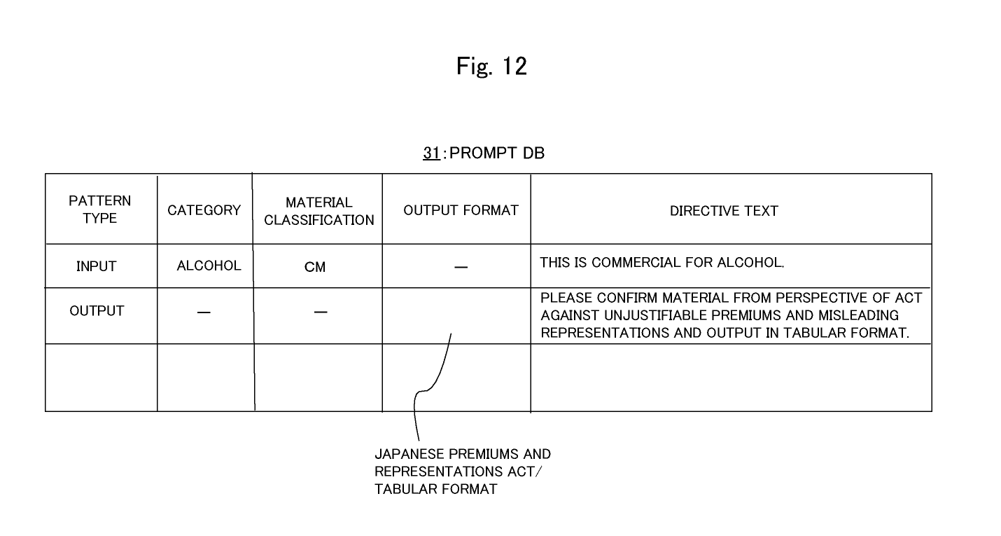

FIG. 12 is an example of a data structure of the prompt DB 31. As illustrated in FIG. 12, the prompt DB 31 stores a plurality of various input patterns and output patterns in association with a pattern type, the category, the material classification, the output format, and the directive text. The pattern type is information indicating whether the pattern is either the input pattern or the output pattern.

As illustrated in FIG. 12, the output format of the prompt DB 31 indicates, for convenience, from which perspective the material is reviewed and how the result of the review is output in a simplified manner, such as “Japanese Premiums and Representations Act/tabular format”. For example, in a case where there are a plurality of options for “from which perspective the material is reviewed”, such as the output format of “please confirm from perspective of Pharmaceutical and Medical Device Act and Health Promotion Act”, the output format indicates them as “Pharmaceutical and Medical Device Act, Health Promotion Act/confirm”. In addition, in a case where there are a plurality of options for “how the result of the review is output”, such as the output format of “please summarize from perspective of Act against Unjustifiable Premiums and Misleading Representations and analyze”, the output format indicates them as “Japanese Premiums and Representations Act/summarize, analyze”. The method of simplifying the output format is not limited to this, and can be optionally set.

For example, in a case where the category detection unit 45 detects that the category of the material is “alcohol” and the material classification is “commercial”, the prompt generation unit 48 extracts the directive text “This is commercial for alcohol.” of the input pattern from the prompt DB 31. In addition, for example, in a case where the output format of the material is “please confirm from perspective of Act against Unjustifiable Premiums and Misleading Representations and output in tabular format”, the prompt generation unit 48 extracts the directive text “Please confirm material from perspective of Act against Unjustifiable Premiums and Misleading Representations and output in tabular format.” of the output pattern associated with “Japanese Premiums and Representations Act/tabular format” from the prompt DB 31. Next, the prompt generation unit 48 combines the input pattern and the output pattern to generate a directive text “This is commercial of alcohol. Please confirm material from perspective of Act against Unjustifiable Premiums and Misleading Representations and output in tabular format.”.

The result acquisition unit 49 inputs the prompt to the LLM and acquires the result of reviewing the material output from the LLM. The result acquisition unit 49 acquires a result that “Material has problem with ○○ from perspective of Health Promotion Act.” by inputting, to the LLM, a prompt including a predetermined material and a directive text that “This is commercial of alcohol. Please confirm material from perspective of Health Promotion Act.”, for example.

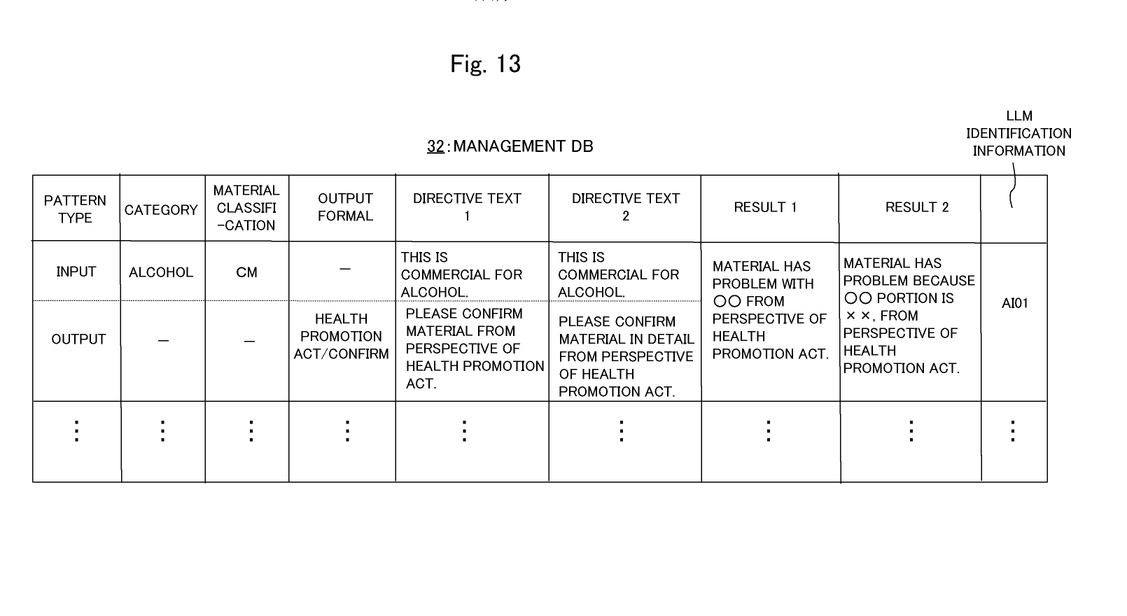

In addition, the result acquisition unit 49 stores and manages the directive text and the result output by the LLM in response to the input of the prompt including the directive text in association with each other in the management DB 32. FIG. 13 illustrates an example of a data structure of the management DB 32. As illustrated in FIG. 13, the management DB 32 may store the pattern type, the category, the material classification, the output format, a directive text 1, a directive text 2, a result 1, a result 2, and identification information of the LLM in association with each other. The identification information of the LLM is information for identifying the LLM to which the prompt is input, and may be information indicating the type of LLM such as Gemini and ChatGPT. The directive text 1 is a first directive text, and the result 1 is a result output by the LLM in response to an input of a prompt including the first directive text 1. The directive text 2 is a second directive text, and the result 2 is a result output by the LLM in response to an input of a prompt including the second directive text 2.

Although details will be described later, in a case where accuracy of a result is poor or additional information is input from a user, the server 1 executes a process of generating a new directive text based on the first directive text and acquiring a result by inputting a prompt including the new directive text to the LLM. Generating the new directive text based on the first directive text and executing processing by the prompt including the new directive text as described above is also referred to as “re-execution”. The management DB 32 may store the presence or absence of the re-execution and the number of times of the re-execution in association with each other.

The prompt generation unit 48 may refer to the management DB 32, extract the input pattern and the output pattern from the prompt DB 31 in consideration of the past directive text and a result thereof, and generate a directive text.

In this manner, the server 1 generates the prompt with reference to the management DB 32 that manages the directive text, the result thereof, and information indicating accuracy of the result such as the number of times of the re-execution, making it possible to improve the accuracy of the result. In other words, the data stored in the management DB 32 can be used by the server 1 to acquire a more accurate result in the future.

The result output unit 50 transmits the result of reviewing the material to the user terminal 2.

After the result of reviewing the material is transmitted to the user terminal 2, the determination unit 51 determines whether a request for the re-execution has been acquired from the user terminal 2. The user confirms the result of reviewing the material by using the user terminal 2 by a predetermined operation, and transmits the request for the re-execution to the server 1, for example, in a case where the user feels that the accuracy is poor or the user wants to add new information to review the material again. The request includes a reason for the re-execution (poor accuracy or adding new information to review, etc.) and additional information as necessary.

In a case where the determination unit 51 acquires the request, the prompt generation unit 48 generates a new directive text based on an immediately preceding directive text according to a recognized request content. For example, in a case where the request is re-execution due to poor accuracy and the immediately preceding directive text is “This is commercial of alcohol. Please confirm material from perspective of Act against Unjustifiable Premiums and Misleading Representations and output in tabular format.”, the prompt generation unit 48 generates a directive text that “This is commercial of alcohol. Please confirm material in detail from perspective of Act against Unjustifiable Premiums and Misleading Representations and output in tabular format.” for requesting a highly accurate result by adding “in detail”, and performs the re-execution. In addition, for example, in a case where the request is re-execution for reviewing the material to which the new information has been added, the prompt generation unit 48 generates a directive text in which the new information has been added to the immediately preceding directive text and performs the re-execution.

In the present disclosure, the generative AI used for the review of the material is the LLM, but the present disclosure is not limited thereto, and any generative AI suitable for the review can be applied according to the material type, the material information, the output format, and the like. In addition, the generative AI suitable for the review may be selected or customized with reference to the management DB 32.

In the present disclosure, the category and the material classification are separated, but the present disclosure is not limited thereto. The category may be set as a material division, and the material division and the material classification that are subordinate concepts may be included in the category that is a superordinate concept. In this case, the category detection unit 45 detects the material division and the material classification as the category, from the information that can be acquired from the uploaded material and the material information.

In the above configuration, the material acquisition unit 40, the material information acquisition unit 41, the non-public information acquisition unit 42, the material type detection unit 44, the category detection unit 45, the information conversion unit 46, the prompt generation unit 48, and the determination unit 51 of the server 1 are examples of a target data acquisition means, a material information acquisition means, a non-public information acquisition means, a material type detection means, a category detection means, an information conversion means, a prompt generation means, and a determination means of the present disclosure, respectively. In addition, the result acquisition unit 49 and the result output unit 50 of the server 1 are examples of a result acquisition means of the present disclosure, and the management DB 32 is an example of a management storage unit of the present disclosure.

### Review Support Processing

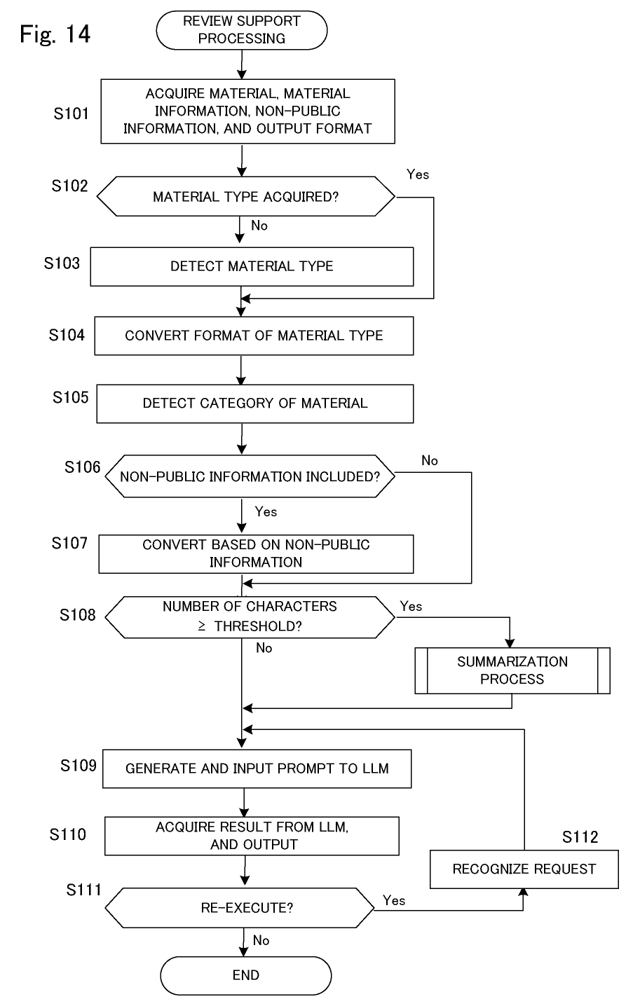

Next, review support processing by the server 1 will be described. FIG. 14 is a flowchart illustrating an example of review support processing by the server 1. This processing is implemented by the processor 12 illustrated in FIG. 2A executing a program prepared in advance.

The user uploads a material desired to be reviewed on the input screen displayed on the user terminal 2. Next, the user registers, on the input screen, material information regarding the material, non-public information that is not desired to be learned by the LLM used for the review, and an output format of a result by the LLM by using the user terminal 2.

First, the server 1 acquires the material to be reviewed, the material information, the non-public information, and the output format from the user terminal 2 (step S101). Next, the server 1 determines whether the material type has been registered as the material information, in other words, whether the material type has been acquired as the material information (step S102). If the material type has been acquired (step S102; Yes), the server 1 proceeds to the process of step S104. On the other hand, if the material type has not been acquired (step S102; No), the server 1 detects the material type from the information that can be acquired from the uploaded material and the material information (step S103).

Next, the server 1 converts the material type of the material into a format readable by the LLM (step S104). Next, the server 1 detects the category and the material classification from the information that can be acquired from the uploaded material and the material information (Step S105). Next, the server 1 determines whether the material after the format conversion of the material type includes the non-public information (step S106). If the non-public information is not included (step S106; No), the server 1 proceeds to the process of step S108. On the other hand, if the non-public information is included (step S106; Yes), the server 1 converts the information that is included in the material and is not desired to be learned by the LLM into other information, based on the non-public information (step S107).

Next, the server 1 determines whether the number of characters of the material is equal to or more than a threshold (step S108). If the number of characters of the material is equal to or more than the threshold (step S108; Yes), the server 1 executes a summarization process. Details of the summarization process will be described later. On the other hand, if the number of characters of the material is less than the threshold (step S108; No), the server 1 generates a prompt and inputs the prompt to the LLM (step S109). Specifically, the server 1 extracts an input pattern and an output pattern from the prompt DB 31 based on the category of the material and the material classification detected in step S105, the output format registered by the user, and the like, and generates a directive text by combining the input pattern and the output pattern. Then, the server 1 generates a prompt including the generated directive text and the material after the information conversion, and inputs the prompt to the predetermined LLM.

Next, the server 1 acquires a result of reviewing the material from the LLM and transmits the result to the user terminal 2 (step S110). At this time, the server 1 stores and manages the directive text, the result output by the LLM in response to the input of the prompt including the directive text, and the presence or absence of the re-execution in association with each other in the management DB 32. The user confirms the result of reviewing the material by using the user terminal 2 by a predetermined operation, and transmits the request for the re-execution to the server 1, for example, in a case where the user feels that the accuracy is poor or the user wants to add new information to review the material again.

Next, after the result of reviewing the material is transmitted to the user terminal 2, the server 1 determines whether a request for the re-execution has been acquired from the user terminal 2. In other words, the server 1 determines whether or not to perform the re-execution (step S111). The request is acquired and if it is determined that the re-execution is to be performed (step S111; Yes), the server 1 recognizes a request content (step S112). The server 1 returns to the process of step S109 in order to generate and re-execute a prompt including a new directive text in response to the request. On the other hand, there is no request and if it is determined that the re-execution is not to be performed (step S111; No), the server 1 ends the review support processing. In this way, by performing the re-execution in response to the request, it is possible to provide a result with a high degree of satisfaction to the user.

### Summarization Process

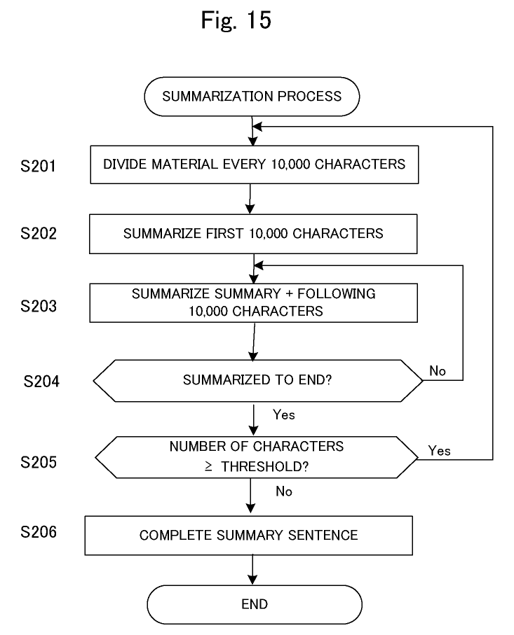

Next, the summarization process by the server 1 will be described. FIG. 15 is a flowchart illustrating an example of the summarization process by the server 1. This processing is implemented by the processor 12 illustrated in FIG. 2A executing a program prepared in advance. In this example, the material is summarized by Example 1 of FIG. 10.

If it is determined that the number of characters of the material is equal to or more than the threshold in step S108 of the review support processing, the server 1 executes the summarization process. First, the server 1 divides the material into the predetermined number of characters, for example, every 10,000 characters (step S201). Next, the server 1 summarizes contents of the first 10,000 characters (step S202). Specifically, the server 1 inputs a prompt including the first 10,000 characters and a directive text requesting a summary of the first 10,000 characters to the LLM, and acquires the summary output from the LLM. Next, the server 1 summarizes contents obtained by adding the following 10,000 characters to the acquired summary (step S203). Specifically, the server 1 inputs a prompt including the acquired summary and the following 10,000 characters and a directive text requesting a summary of the acquired summary and the following 10,000 characters to the LLM, and acquires the summary output from the LLM.

Next, the server 1 determines whether the material has been summarized to the end (step S204). If it is determined that the material has not been summarized to the end (step S204; No), the server 1 returns to the process of step S203. On the other hand, if it is determined that the material has been summarized to the end (step S204; Yes), the server 1 determines whether the number of characters in the summary is equal to or more than a threshold (step S205). If the number of characters in the summary is equal to or more than the threshold (step S205; Yes), the server 1 returns to the process of step S201 and summarizes the summary in order to reduce the number of characters. On the other hand, if the number of characters in the summary is less than the threshold (step S205; No), the server 1 ends the summarization process, and proceeds to the process of step S109 of the review support processing illustrated in FIG. 14. In this case, the review support processing is executed by generating a prompt including a predetermined directive text and the summary having the number of characters less than the threshold.

According to the review support system 100, it is possible to review target data by using the generative AI without requiring the user to input the directive text. Further, since the review support system 100 automatically converts the material type of the target data into the material type readable by the LLM, it is possible to greatly reduce a burden on a person in charge of review who has little knowledge about the generative AI. Furthermore, since the review support system 100 automatically converts information that is included in the target data and is desired to be non-public into other information, a risk of information leakage can be reduced. In addition, the review support system 100 generates the directive text by combining the input pattern and the output pattern based on the registered content of the user, making it possible to easily generate an appropriate directive text and a prompt including the directive text. That is, according to the review support system 100, it is possible to easily generate the prompt necessary for the review using the generative AI only by registering the information regarding the target data and the desired output format by the user. Therefore, it is possible to provide, in review of target data, support for reducing a burden on a person in charge of the review and improving accuracy of the review.

### Modified Example

In the above example embodiment, the user uses the user terminal 2, but the present disclosure is not limited thereto, and the user may use a user terminal having a function of the server 1. In this case, the user terminal executes the review support processing executed by the server 1, and supports the user to easily and appropriately review a material by using the generative AI.

### Second Example Embodiment

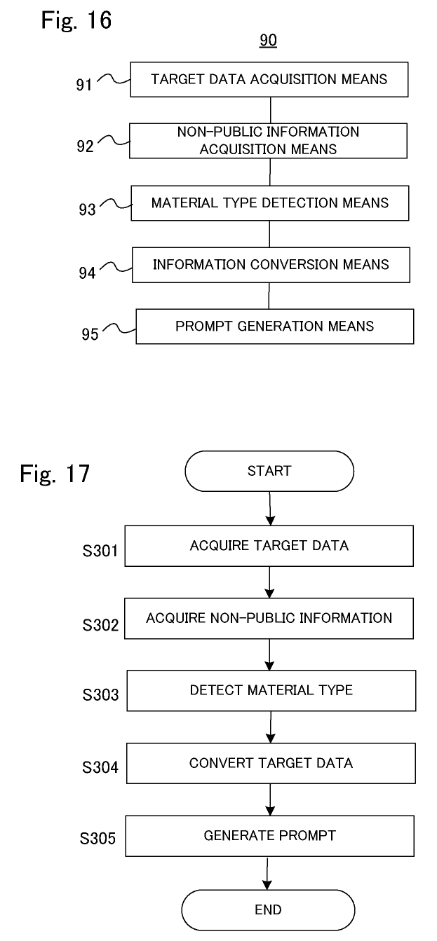

FIG. 16 is a block diagram illustrating an example of a functional configuration of a review support device of the present disclosure. A review support device 90 includes a target data acquisition means 91, a non-public information acquisition means 92, a material type detection means 93, an information conversion means 94, and a prompt generation means 95.

FIG. 17 is a flowchart illustrating an example of processing by the review support device 90. The target data acquisition means 91 acquires target data for review (step S301). The non-public information acquisition means 92 acquires non-public information regarding the target data (step S302). The material type detection means 93 detects a material type of the target data (step S303). The information conversion means 94 converts the target data into information readable by a large language model, based on the material type and the non-public information (step S304). The prompt generation means 95 generates a plurality of prompts to be input to the large language model, based on the converted target data. According to the review support device 90, it is possible to perform appropriate information conversion based on the acquired target data and non-public information, and easily generate the plurality of prompts necessary for the review using the large language model. Therefore, it is possible to provide, in review of target data, support for reducing a burden on a person in charge of the review and improving accuracy of the review.

A part or all of the example embodiments including modified examples described above may also be described as the following supplementary notes, but not limited thereto.

### Supplementary Note 1

A review support device including:

a target data acquisition means for acquiring target data for review;

a non-public information acquisition means for acquiring non-public information regarding the target data;

a material type detection means for detecting a material type of the target data;

information conversion means for converting the target data into information readable by a large language model, based on the material type and the non-public information; and

a prompt generation means for generating a plurality of prompts to be input to the large language model, based on the converted target data.

### Supplementary Note 2

The review support device according to Supplementary Note 1, wherein the prompt generation means generates a directive text composed of an input pattern that is a direction based on the target data and an output pattern that is a direction based on an output format of a result output by the large language model to which the prompts are input, and generates a prompt including the directive text and the converted target data.

### Supplementary Note 3

The review support device according to Supplementary Note 2, wherein the prompt generation means includes a category detection means for detecting a category of the target data, and selects a combination of the input pattern and the output pattern based on the detected category to generate a directive text.

### Supplementary Note 4

The review support device according to Supplementary Note 3, further including a material information acquisition means for acquiring material information regarding the target data,

wherein the category detection means detects the category based on the material type and the material information of the target data.

### Supplementary Note 5

The review support device according to Supplementary Note 1, further including a result acquisition means for acquiring and outputting a result output by the large language model to which the prompts are input,

wherein the prompt generation means generates a plurality of prompts requesting a summary for reducing a data amount of the converted target data, and

the result acquisition means acquires a summary of the target data by executing, a plurality of times, a process of acquiring a result output by the large language model to which the prompts requesting the summary are input.

### Supplementary Note 6

The review support device according to Supplementary Note 5, further including a determination means for determining whether accuracy of the result is poor,

wherein the prompt generation means generates a directive text requesting a highly accurate result in a case where it is determined that the accuracy of the result is poor, and generates a prompt including the directive text and the converted target data, and

the result acquisition means acquires the highly accurate result by re-executing a process of acquiring a result output by the large language model in which the prompt is input.

### Supplementary Note 7

The review support device according to Supplementary Note 6, further including a management storage unit for storing the directive text, the result output by the large language model in response to the input of the prompt including the directive text, and presence or absence of the re-execution in association with each other,

wherein the prompt generation means generates the prompt with reference to the management storage unit.

### Supplementary Note 8

The review support device according to Supplementary Note 1, wherein the prompt generation means generates a prompt requesting a result of reviewing whether the target data complies with any one or more of a legal regulation, a voluntary regulation of an industry group, and an examination standard of a medium.

### Supplementary Note 9

A review support method executed by a review support device, the method including:

acquiring target data for review;

acquiring non-public information regarding the target data;

detecting a material type of the target data;

converting the target data into information readable by a large language model, based on the material type and the non-public information; and

generating a plurality of prompts to be input to the large language model, based on the converted target data.

### Supplementary Note 10

A program executed by a review support device including a computer, the program causing the computer to execute processing including:

acquiring target data for review;

acquiring non-public information regarding the target data;

detecting a material type of the target data;

converting the target data into information readable by a large language model, based on the material type and the non-public information; and

generating a plurality of prompts to be input to the large language model, based on the converted target data.

### Supplementary Note 11

The review support device according to claim 1, further including a non-public conversion means for converting information that is included in the target data and is not desired to be input to the large language model into other information, based on the non-public information.

Some or all of the configurations described in Supplementary Notes 2 to 8 and 11 dependent on the above-described Supplementary Note 1 can also be dependent on Supplementary Notes 9 and 10 by a dependency relationship similar to that of Supplementary Notes 2 to 8 and 11. Some or all of the configurations described as the Supplementary Notes can be similarly dependent on not only the Supplementary Notes 1, 9, and 10, but also diverse pieces of hardware and software, various recording means for recording software, or systems without departing from the above-described example embodiments.

While the present disclosure has been described with reference to the example embodiments and examples, the present disclosure is not limited to the above example embodiments and examples. Various changes which can be understood by those skilled in the art within the scope of the present disclosure can be made in the configuration and details of the present disclosure. In other words, the present disclosure naturally includes various modifications and alterations that a person skilled in the art would be able to make in accordance with the entire disclosure, including the scope of the claims, and the technical ideas.

### DESCRIPTION OF SYMBOLS

1 Server

2 User terminal

31 Prompt DB

32 Management DB

40 Material acquisition unit

41 Material information acquisition unit

42 Non-public information acquisition unit

43 Output format acquisition unit

44 Material type detection unit

45 Category detection unit

46 Information conversion unit

47 Summarization unit

48 Prompt generation unit

49 Result acquisition unit

50 Result output unit

51 Determination unit

100 Review support system

1. A review support device including:
a memory configured to store instructions; and
a processor configured to execute the instructions to:
acquire target data for review;
acquire non-public information regarding the target data;
detect a material type of the target data;
convert the target data into information readable by a language model, based on the material type and the non-public information; and
generate a plurality of prompts to be input to the language model, based on the converted target data.

2. The review support device according to claim 1, wherein the processor generates a directive text composed of an input pattern that is a direction based on the target data and an output pattern that is a direction based on an output format of a result output by the language model to which the prompts are input, and generates a prompt including the directive text and the converted target data.

3. The review support device according to claim 2, wherein the processor detects a category of the target data, and selects a combination of the input pattern and the output pattern based on the detected category to generate a directive text.

4. The review support device according to claim 3,
wherein the processor is further configured to execute the instructions to acquire material information regarding the target data, and
wherein the processor detects the category based on the material type and the material information of the target data.

5. The review support device according to claim 1,
wherein the processor is further configured to acquire and output a result output by the language model to which the prompts are input,
wherein the processor generates a plurality of prompts requesting a summary for reducing a data amount of the converted target data, and
wherein the processor acquires a summary of the target data by executing, a plurality of times, a process of acquiring a result output by the language model to which the prompts requesting the summary are input.

6. The review support device according to claim 5,
wherein the processor is further configured to determine whether accuracy of the result is poor,
wherein the processor generates a directive text requesting a highly accurate result in a case where it is determined that the accuracy of the result is poor, and generates a prompt including the directive text and the converted target data, and
wherein the processor acquires the highly accurate result by re-executing a process of acquiring a result output by the language model in which the prompt is input.

7. The review support device according to claim 6, further comprising a management storage for storing the directive text, the result output by the language model in response to the input of the prompt including the directive text, and presence or absence of the re-execution in association with each other,
wherein the processor generates the prompt with reference to the management storage.

8. The review support device according to claim 1, wherein the processor generates a prompt requesting a result of reviewing whether the target data complies with any one or more of a legal regulation, a voluntary regulation of an industry group, and an examination standard of a medium.

9. A review support method executed by a computer, comprising:
acquiring target data for review;
acquiring non-public information regarding the target data;
detecting a material type of the target data;
converting the target data into information readable by a language model, based on the material type and the non-public information; and
generating a plurality of prompts to be input to the language model, based on the converted target data.

10. A non-transitory computer-readable recording medium storing a program executed by a computer, the program causing the computer to execute processing comprising:
acquiring target data for review;
acquiring non-public information regarding the target data;
detecting a material type of the target data;
converting the target data into information readable by a language model, based on the material type and the non-public information; and
generating a plurality of prompts to be input to the language model, based on the converted target data.
